(19) United States
(12) Patent Application Publication
(10) Pub. No.: US 2025/0167534 A1
(43) Pub. Date: May 22, 2025

(54) DRIVE ASSEMBLY FOR OVERHEAD CABLE MANAGEMENT SYSTEM OF A DEVICE

(71) Applicant: Honda Motor Co., Ltd., Tokyo (JP)

(72) Inventors: Mark David Bartlett, Dublin, OH (US); Charles Stephen Haase, Delaware, OH (US)

(21) Appl. No.: 18/513,271

(22) Filed: Nov. 17, 2023

(51) Int. Cl. H02G 3/00; G02B 27/01

(52) U.S. Cl. CPC H02G 3/263; G02B 27/0176

(57) ABSTRACT

A drive assembly for an overhead cable management system has an overhead sheet including a first surface and a second surface disposed opposite to the first surface and arranged facing a ground. The drive assembly includes a first roller adapted to be arranged on the first surface and move on the first surface and having at least one first magnet. The drive assembly also includes a second roller adapted to magnetically couple with the first roller and is disposed underneath the overhead sheet, contacting the second surface. The second roller includes at least one second magnet to magnetic couple the second roller assembly with the first roller assembly.

### BACKGROUND

The disclosed subject matter relates generally to a virtual reality system. More particularly, the disclosed subject matter relates to an overhead cable management system for a virtual reality headset.

Virtual reality systems include virtual reality headsets that are worn by a user while moving inside a space. A cable generally extends from the virtual reality headset to share data as well power to the virtual reality headset. However, as the person wearing the headset moves around, the cable is laid out randomly on the floor of the space. Moreover, the person wearing the headset cannot see the cable spread across the floor, making the movement of the person difficult.

### SUMMARY

In accordance with one embodiment of the present disclosure, a drive assembly for an overhead cable management system for a device is provided. The overhead cable management system has an overhead sheet including a first surface and a second surface disposed opposite to the first surface and arranged facing a ground. The drive assembly includes a first roller adapted to be arranged and move on the first surface and having at least one first magnet. The drive assembly further includes a second roller adapted to magnetically couple with the first roller and configured to be disposed underneath the overhead sheet, contacting the second surface. The second roller includes at least one second magnet adapted to facilitate the magnetic coupling of the second roller with the first roller. A cable of the device is coupled with the second roller.

In accordance with another embodiment of the present disclosure, an overhead cable management system for a device is provided. The overhead cable management system includes an overhead sheet having a first surface and a second surface disposed opposite to the first surface and arranged facing a ground. The overhead cable management system further includes a first roller arranged on the first surface and configured to move on the first surface. The first roller includes at least one first magnet. Moreover, the overhead cable management system includes a second roller magnetically coupled with the first roller and disposed underneath the overhead sheet, contacting the second surface. The second roller includes at least one second magnet magnetically coupling the second roller with the first roller. A cable of the device is coupled with the second roller.

In accordance with yet a further embodiment of the present disclosure a virtual reality system is disclosed. The virtual reality system includes a virtual reality headset and at least one cable attached to the virtual reality headset and configured to facilitate an operation of the virtual reality headset. The virtual reality system also includes a frame having a plurality of pillars extending vertically from a ground and an overhead sheet supported on the plurality of pillars and disposed at a vertical distance from the ground defining a working space. The overhead sheet has a first surface and a second surface disposed opposite to the first surface and arranged facing the ground. The virtual reality system further includes a first roller assembly arranged on the first surface and configured to move on the first surface. The first roller assembly includes a first roller having at least one first magnet, and a pair of stabilizers attached to the first roller and arranged spaced apart and opposite to each other. The pair of stabilizers stabilize the movement of the first roller assembly on the first surface. Moreover, the virtual reality system includes a second roller assembly magnetically coupled with the first roller assembly and disposed underneath the overhead sheet, contacting the second surface. The second roller assembly includes a yoke and a second roller coupled to the yoke and arranged inside the yoke. The second roller includes at least one second magnet magnetically coupling the second roller assembly with the first roller assembly. Also, the cable is coupled to the yoke of the second roller assembly.

### BRIEF DESCRIPTION OF THE DRAWINGS

Certain embodiments of the present disclosure will be better understood from the following description taken in conjunction with the accompanying drawings in which:

FIG. 1 a front perspective view of a virtual reality system having an overhead cable management system to hold the cable above a ground and having a drive assembly to move the cable in the overhang position, in accordance with one embodiment of the present disclosure;

FIG. 2 is a side perspective view of a portion of a guard structure of the overhead cable management system of FIG. 1, in accordance with one embodiment of the present disclosure;

FIG. 3 is a front view of the guard structure depicting inner sides of a first bumper and a second bumper of the guard structure of FIG. 2, in accordance with one embodiment of the present disclosure;

FIG. 4 is a perspective view of the drive assembly of FIG. 1 having a first roller assembly arranged on a first surface of an overhead sheet and a second roller assembly magnetically coupled to the first roller assembly and disposed underneath the overhead sheet, in accordance with one embodiment of the present disclosure;

FIG. 5 is a front view of the drive assembly of FIG. 1 having the first roller assembly arranged on the first surface of an overhead sheet and the second roller assembly magnetically coupled to the first roller assembly and disposed underneath the overhead sheet, in accordance with one embodiment of the present disclosure;

FIG. 6 is a partially exploded view of a first roller of the first roller assembly of FIG. 4 and depicting a plurality of first magnets arranged inside a housing, in accordance with one embodiment of the present disclosure; and

FIG. 7 is a partially exploded view of a second roller of the second roller assembly of FIG. 4 and depicting a plurality of second magnets arranged inside an enclosure, in accordance with one embodiment of the present disclosure.

### DETAILED DESCRIPTION OF EXEMPLARY EMBODIMENTS

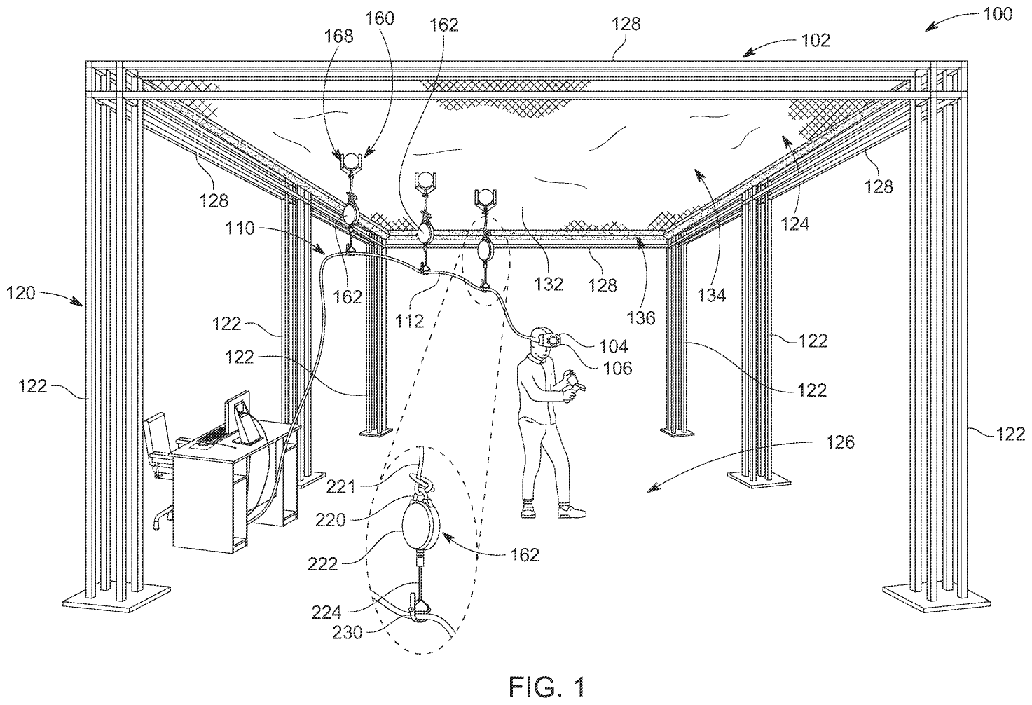

A few inventive aspects of the disclosed embodiments are explained in detail below with reference to the various figures. Exemplary embodiments are described to illustrate the disclosed subject matter, not to limit its scope, which is defined by the claims. Those of ordinary skill in the art will recognize a number of equivalent variations of the various features provided in the description that follows. Embodiments are hereinafter described in detail in connection with the views and examples of FIGS. 1-7, wherein like numbers indicate the same or corresponding elements throughout the views.

Referring to FIG. 1, a system 100, for example, a virtual reality system 102, having a device 104, for example, a virtual reality headset 106, adapted to be operated or used by a person and an overhead cable management system 110 for managing a cable 112 that is coupled to the device 104 is shown, in accordance with one embodiment of the disclosure. Although, the system 100 is shown and contemplated as the virtual reality system 102, it may be appreciated that the system 100 may include any other system in which a positioning of a cable connected with a device needs to be managed inside a space when the person operates or uses the device and moves inside the space. The cable 112 is coupled to the virtual reality headset 106 (hereinafter simply referred to as headset 106) and is configured to facilitate a flow of data and power to the headset 106. The overhead cable management system 110 manages the position and the movement of the cable 112 as the user moves inside an area/space while wearing the headset 106 such that the cable 112 does not interfere or obstruct the movement of the person/wearer of the headset inside the working space.

As shown, the overhead cable management system 110 includes a frame 120 having a plurality of pillars 122 extending vertically from the ground and an overhead sheet 124 supported on the plurality of pillars 122 and disposed at a vertical distance from the ground defining a workspace 126 for the person wearing the headset 106. Further, to support the overhead sheet 124, the frame 120 may include a plurality of beams 128 extending between the pillars 122 and supported on the top ends of the pillars 122. Accordingly, the overhead sheet 124 is supported on the pillars 122 and the beams 128, covering an area of the rectangle defined between the beams 128. Moreover, the overhead sheet 124 has a first surface 130 and a second surface 132 disposed opposite to the first surface 130 and arranged facing the ground. In an embodiment, the overhead sheet 124 is a tarpaulin mat 134 having an outer edge, and the overhead cable management system 110 further includes a guard structure 136 extending along the outer edge of the overhead sheet 124 and coupled to the overhead sheet 124.

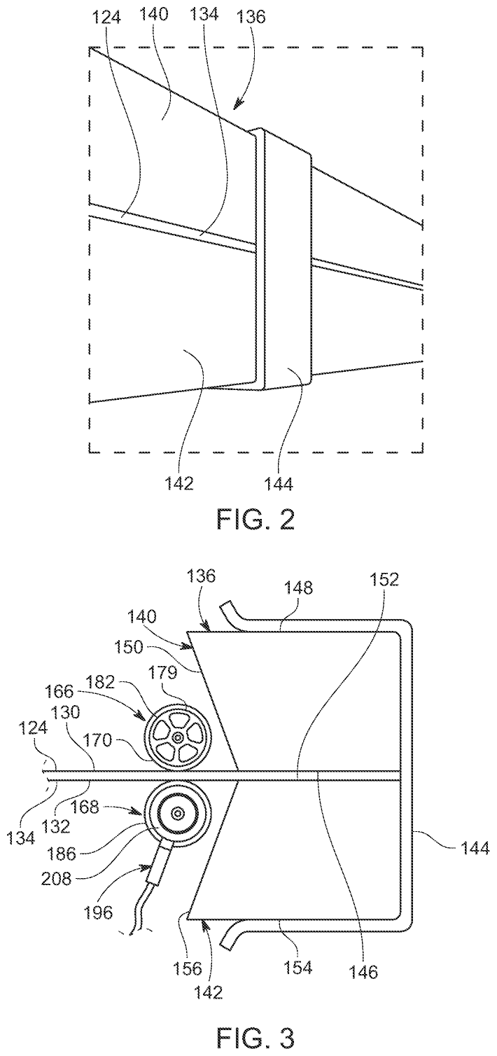

In an embodiment, as shown in FIG. 2, the guard structure 136 includes a pair of bumpers, for example, a first bumper 140 and a second bumper 142, extending along the entire outer edge of the overhead sheet 124. The first bumper 140 extends upwardly of the first surface 130 of the overhead sheet 124, while the second bumper 142 extends downwardly of the second surface 132 of the overhead sheet 124 in a vertical direction. Moreover, the guard structure 136 may include a plurality of clips 144 arrayed along the outer edge of the overhead sheet 124 and attached to the first bumper 140 and the second bumper 142 to each other and with the overhead sheet 124. Referring to FIG. 3, the first bumper 140 includes a bottom side 146 arranged contacting the first surface 130 of the overhead sheet 124, a top side 148 arranged opposite to the bottom side 146, and an inner side 150 extending from the bottom side 146 and the top side 148. The inner side 150 extends obliquely and inwardly in the vertical direction from the top side 148 to the bottom side 146 such that a width of the first bumper 140 decreases from the top side 148 to the bottom side 146 in the vertical direction. Similar to the first bumper 140, the second bumper 142 includes an upper side 152 arranged contacting the second surface 132 of the overhead sheet 124, a lower side 154 arranged opposite to the upper side 152, and an inner side 156 extending from the upper side 152 and the lower side 154. The inner side 156 extends obliquely and inwardly in the vertical direction from the lower side 154 to the upper side 152 such that a width of the second bumper 142 decreases from the lower side 154 to the upper side 152 in the vertical direction. Accordingly, the inner sides 150, 156 of the bumpers 140, 142 together define a substantially convex shape with the overhead sheet 124 extending from an apex of the convex side/shape.

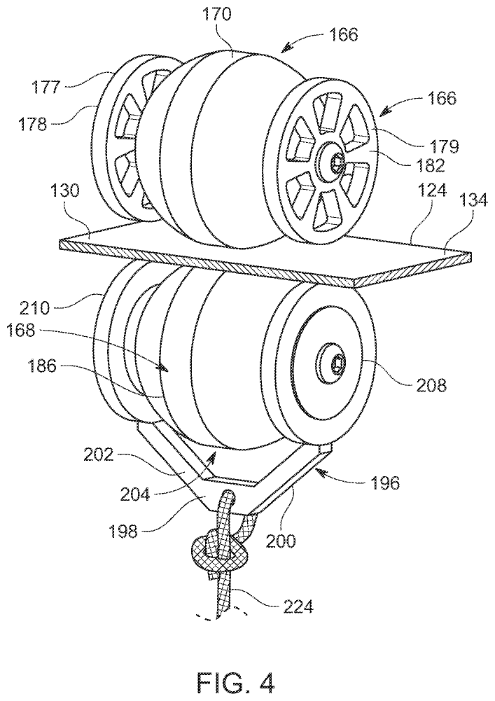

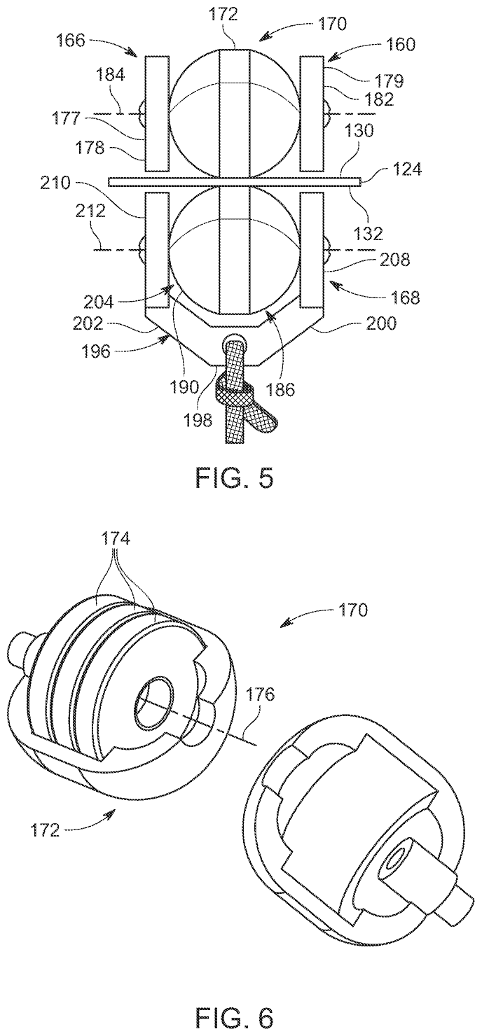

Further, the overhead cable management system 110 includes a drive assembly 160 and at least one retractable leash assembly 162 configured to hold a portion of the cable 112 above the ground and to enable a movement of the cable 112 in an overhang position inside the workspace 126 as the person wearing the headset 106 moves inside the workspace 126. Referring to FIGS. 4 and 5, the drive assembly 160 is movably engaged to the overhead sheet 124 and includes a first roller assembly 166 movably arranged on the first surface 130 of the overhead sheet 124 and a second roller assembly 168 magnetically coupled with the first roller assembly 166. The second roller assembly 168 is disposed underneath the overhead sheet 124, contacting the second surface 132 and moves along the second surface 132.

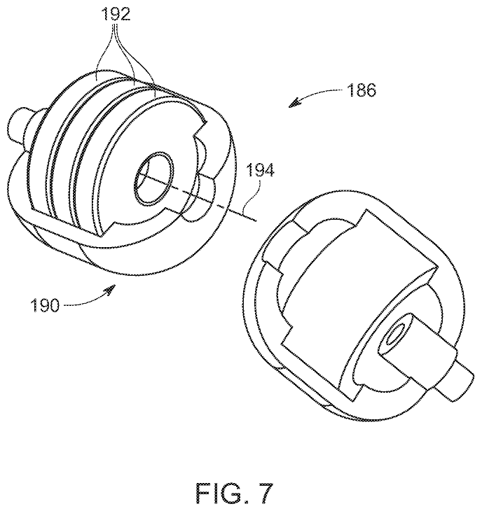

Referring to FIGS. 4 to 6, the first roller assembly 166 includes a first roller 170 arranged contacting the first surface 130 and moves on the first surface 130 of the overhead sheet 124. The first roller 170 has a housing 172 and at least one first magnet 174 arranged inside the housing 172. In the illustrated embodiment, the at least one first magnet 174 includes a plurality of first magnets 174 arranged inside the housing 172. As shown, the housing 172 is a substantially cylindrical housing, while each of the first magnet 174 is a ring magnet. In such a case, the plurality of first magnets 174 is stacked inside the housing 172 such that central axes 176 of the first magnets 174 align with each other, and lies along a central longitudinal axis of the housing 172 i.e., a rotational axis of the first roller 170. Moreover, the first roller assembly 166 includes a pair of stabilizers 177, 179, for example, a pair of wheels 178, 182 rotatably coupled to the housing 172 and arranged diametrically opposite to each other. The wheels 178, 182 and the first magnets 174 are arranged such that the axis of rotation 184 of each of the wheels 178, 182 and the central axis 176 of each of the first magnets 174 are arranged aligned to/coinciding each other. Although the plurality of ring magnets is shown and contemplated, it may be appreciated that a single hollow cylindrical first magnet 174 may also be used. In the illustrated embodiment, shown in FIG. 6, the housing 172 is a split housing having two halves. In some embodiments, the stabilizers 177, 179 may be omitted.

Similar to the first roller assembly 166, referring to FIGS. 4, 5 and FIG. 7, the second roller assembly 168 includes a second roller 186 magnetically coupled to the first roller 170 and arranged contacting the second surface 132 to enable the movement of the second roller assembly 168 along the second surface 132. As shown, the second roller 186 includes an enclosure 190 and at least one second magnet 192 arranged inside the enclosure 190. In the illustrated embodiment, the at least one second magnet 192 includes a plurality of second magnets arranged inside the enclosure 190. As shown, the enclosure 190 is a substantially cylindrical enclosure, while each of the second magnets 192 is a ring magnet. In such a case, the plurality of second magnets 192 is stacked inside the enclosure 190 such that central axes 194 of the second magnets 192 align with each other such that the central axes 194 lie/extend along a central longitudinal axis of the cylindrical enclosure 190 (i.e., rotational axis of the second roller 186). Although the plurality of ring magnets is shown and contemplated as the second magnets 192, it may be appreciated that a single hollow cylindrical second magnet 192 may also be used.

As shown in FIGS. 4 and 5, the second roller assembly 168 also includes a yoke 196 having a central body 198 and two arms 200, 202 extending in a longitudinal direction from the central body 198 and arranged on opposite sides of the central body 198. Accordingly, a space 204 is defined between the arms 200, 202 of the yoke 196, and the second roller 186 is arranged inside the space 204 and is coupled to the arms 200, 202. In the illustrated embodiment, the yoke 196 further includes a pair of hollow disks 208, 210 arranged at ends of the arms 200, 202 and coupled with the second roller 186. In some embodiments, the bearings may be arranged inside cavities of the hollow disks 208, 210 and the enclosure 190 and hence the second roller 186 is coupled/attached with the bearings to enable a rotation of the second roller 186 about a rotational axis of the second roller 186 relative to the yoke 196. It may be envisioned that the rotational axis of the second roller 186 coincides with the central axes 194 of the second magnets 192. Hollow disks 208, 210 are configured to slide along the second surface 132 of the overhead sheet 124 as the user moves inside the workspace 126, wearing the headset 106, thereby pulling the second roller assembly 168. In some embodiments, the hollow disks 208, 210 may be movable bodies, for example, wheels, configured to rotate about respective central axis as the second roller assembly 168 is pulled due to the movement of the user wearing the headset 106. In such a case, the rotational axis 212 of each of the wheels 208, 210 coincides with the central axis 194 of each of the second magnets 192. It may be appreciated that the second roller 186 remains in contact with the second surface 132, and moves along the second surface 132. The yoke 196 enables stabilizing of the second roller 186 on the second surface 132 as user moves inside the workspace 126. In some embodiments, the yoke 196 may also be omitted. As, the second magnets 192 and the first magnets 174 enable the magnetic coupling of the second roller assembly 168 with the first roller assembly 166, the first roller assembly 166 keeps the second roller assembly 168 engaged to the second surface 132 of the overhead sheet 124, during the displacement of the second roller assembly 168 along the second surface 132 as the wearer of the headset 106 moves inside the workspace 126.

As shown in FIG. 1, the second roller assembly 168 is connected to the cable 112 via the at least one retractable leash assembly 162 to hold the cable 112 in the overhang position. As shown, the retractable leash assembly 162 includes a hook 220 coupled to the central body 198 of the yoke 196 via a leash 221, a re-coiler 222 having a winch drum (not shown) around which a rope 224 is wound such a portion of the rope 224 extends outwardly of the re-coiler 222. The rope 224 is adapted to be unwound from the drum upon application of pull force on the rope 224. The rope 224 coils around the drum upon removal of the pull force on the free end of the rope 224. Further, the retractable leash assembly 162 includes a coupler 230, for example, a hook adapted to engage/couple to the cable 112 to position at least a portion of the cable 112 above the ground. The retractable leash assembly 162 is configured to absorb any jerk applied by the user during the movement of the user inside the workspace 126, thereby preventing/restricting a disengagement of the second roller assembly 168 from the overhead sheet 124.

The foregoing description of embodiments and examples has been presented for purposes of illustration and description. It is not intended to be exhaustive or to limit the invention to the forms described. Numerous modifications are possible in light of the above teachings. Some of those modifications have been discussed and others will be understood by those skilled in the art. The embodiments were chosen and described in order to best illustrate certain principles and various embodiments as are suited to the particular use contemplated. The scope of the invention is, of course, not limited to the examples or embodiments set forth herein, but can be employed in any number of applications and equivalent devices by those of ordinary skill in the art. Rather it is hereby intended the scope of the invention be defined by the claims appended hereto.

What is claimed is:

1. A drive assembly for an overhead cable management system for a device, the overhead cable management system having an overhead sheet including a first surface and a second surface disposed opposite to the first surface and arranged facing a ground, the drive assembly comprising:
a first roller adapted to be arranged and move on the first surface and including at least one first magnet; and
a second roller adapted to magnetically couple with the first roller and configured to be disposed underneath the overhead sheet, contacting the second surface, the second roller includes at least one second magnet adapted to facilitate the magnetic coupling of the second roller with the first roller,
wherein a cable of the device is coupled with the second roller.

2. The drive assembly of claim 1, wherein the first roller includes a housing and the at least one first magnet includes a plurality of first ring magnets arranged inside the housing such that central axes of the plurality of first ring magnets coincide with a rotational axis of the first roller.

3. The drive assembly of claim 1, wherein the drive assembly includes a pair of stabilizers coupled to the first roller and arranged on opposite sides of the first roller to stabilize the movement of the first roller on the first surface.

4. The drive assembly of claim 1, wherein the pair of stabilizers includes a pair of wheels.

5. The drive assembly of claim 1, wherein the second roller includes an enclosure and the at least one second magnet includes a plurality of second ring magnets arranged inside the enclosure such that central axes of the plurality of second ring magnets coincide with a rotational axis of the second roller.

6. The drive assembly of claim 5, wherein the drive assembly includes a yoke coupled to the yoke to stabilize the second roller on the second surface, wherein the second roller is arranged inside the yoke and the cable of the device is coupled to the yoke.

7. An overhead cable management system for a device, comprising:
an overhead sheet having a first surface and a second surface disposed opposite to the first surface and arranged facing a ground;
a first roller arranged on the first surface and configured to move on the first surface and including a first roller having at least one first magnet; and
a second roller magnetically coupled with the first roller and disposed underneath the overhead sheet, contacting the second surface, the second roller includes at least one second magnet magnetically coupling the second roller with the first roller,
wherein a cable of the device is coupled with the second roller.

8. The overhead cable management system of claim 7, wherein the first roller includes a housing and the at least one first magnet includes a plurality of first ring magnets arranged inside the housing and stacked such that central axes of the plurality of first ring magnets coincide with a rotational axis of the first roller.

9. The overhead cable management system of claim 7, wherein the second roller includes an enclosure and the at least one second magnet includes a plurality of second ring magnets arranged inside the enclosure such that central axes of the plurality of second ring magnets coincide with a rotational axis of the second roller.

10. The overhead cable management system of claim 7 further including
a pair of stabilizers coupled to the first roller and arranged on opposite sides of the first roller to stabilize the movement of the first roller on the first surface, and
a yoke coupled to the second roller to stabilize the second roller on the second surface, wherein the second roller is arranged inside the yoke.

11. The overhead cable management system of claim 10, wherein the pair of stabilizers includes a pair of wheels.

12. The overhead cable management system of claim 10 further including a retractable leash assembly having a leash coupled to the yoke, wherein the cable of the device is attached to the retractable leash assembly.

13. The overhead cable management system of claim 7, wherein the overhead sheet includes a tarpaulin mat.

14. The overhead cable management system of claim 7 further including a pair of bumpers extending along an outer edge of the overhead sheet, wherein
a first bumper of the pair of bumpers extends upwardly of the overhead sheet and configured to retain the first roller on the first surface of the overhead sheet, and
a second bumper of the pair of bumpers extends downwardly of the overhead sheet and configured to retain the second roller engaged with the second surface of the overhead sheet.

15. A virtual reality system, comprising:
a virtual reality headset;
at least one cable attached to the virtual reality headset and configured to facilitate an operation of the virtual reality headset;
a frame having a plurality of pillars extending vertically from a ground;
an overhead sheet supported on the plurality of pillars and disposed at a vertical distance from the ground defining a working space, the overhead sheet having a first surface and a second surface disposed opposite to the first surface and arranged facing the ground;
a first roller assembly arranged on the first surface and configured to move on the first surface and including
a first roller having at least one first magnet, and
a pair of stabilizers attached to the first roller and arranged spaced apart and opposite to each other, wherein the pair of stabilizers stabilize the movement of the first roller assembly on the first surface; and
a second roller assembly magnetically coupled with the first roller assembly and disposed underneath the overhead sheet, contacting the second surface, the second roller assembly including
a yoke, and
a second roller arranged inside the yoke and coupled to the yoke, the second roller includes at least one second magnet magnetically coupling the second roller assembly with the first roller assembly, wherein the cable is coupled to the yoke of the second roller assembly.

16. The virtual reality system of claim 15, wherein
the first roller includes a housing and the at least one first magnet includes a plurality of first ring magnets arranged inside the housing, and
the plurality of first ring magnets is stacked such that central axes of the plurality of first ring magnets coincide with a rotational axis of the first roller.

17. The virtual reality system of claim 15, wherein
the second roller includes an enclosure and the at least one second magnet includes a plurality of second ring magnets arranged inside the enclosure,
wherein, the plurality of second ring magnets is stacked such that central axes of the plurality of second ring magnets coincide with a rotational axis of the second roller.

18. The virtual reality system of claim 15, wherein the overhead sheet includes a tarpaulin mat.

19. The virtual reality system of claim 15 further including a retractable leash assembly having a leash coupled to the yoke, wherein the cable is attached to the retractable leash assembly.

20. The virtual reality system of claim 15 further including a pair of bumpers extending along an outer edge of the overhead sheet, wherein
a first bumper of the pair of bumpers extends upwardly of the overhead sheet and configured to retain the first roller assembly on the first surface of the overhead sheet, and
a second bumper of the pair of bumpers extends downwardly of the overhead sheet and configured to retain the second roller assembly engaged with the second surface of the overhead sheet.
